(19) United States
(12) Patent Application Publication
(10) Pub. No.: US 2002/0087404 A1
(43) Pub. Date: Jul. 4, 2002

(54) System and method for network based marketing

(75) Inventors: Robert Carl Silkey, La Jolla, CA (US); David W. Evans, La Jolla, CA (US); Teodorico P. Ricasa, La Jolla, CA (US); Dennis Gerasimenko, San Diego, CA (US); Michael Kremliovsky, San Diego, CA (US)

Correspondence Address: LYON & LYON LLP, 633 WEST FIFTH STREET, SUITE 4700, LOS ANGELES, CA, 90071, US

(73) Assignee: Einstein Industries, Inc.

(21) Appl. No.: 09/754,182

(22) Filed: Jan. 3, 2001

(51) Int. Cl. G06F 17/60

(52) U.S. Cl. 705/14

(57) ABSTRACT

A system and method for network based marketing is presented. A server computer resides on a network and maintains a dynamically populated database of clients, patients, colleagues, and other recipients. A service provider authors or selects a communiqué to be sent to a set of recipients and submits to the server the communiqué and criteria defining the set of recipients. A service provider authors or selects a communiqué to be sent to a set of recipients and submits to the server the communiqué and criteria defining the set of recipients. The server receives the communiqué and the criteria, filters the database to determine the list of recipients, personalizes the communiqué for each of the recipients in the list and then delivers the personalized communiqué to each recipient, using the network as the delivery medium.

### BACKGROUND OF THE INVENTION

1. Field of the Invention

The present invention relates generally to the field of marketing and more particularly to the field of network based marketing implemented over an electronic communications network.

2. Related Art

In professional service provider practices, a significant percentage of new clients and/or patients are derived from “word-of-mouth” referrals given by current clients and/or patients. Many practices expend a considerable portion of their marketing budgets to maintain practice visibility among current clients and/or patients. These marketing activities usually include mailing out items such as practice newsletters, holiday greeting cards, and updates concerning new technology, new staff, new developments in the practice field, etc. Some of these materials are also mailed to prospective clients that have indicated an interest.

These conventional “shot gun blast” types of mass mailings, although usually necessary for the survival of the practice, can be prohibitively expensive. Typically, the penetration and return value per marketing dollar spent on conventional marketing methods in these professional service provider industries is very low. Accordingly, the shortcomings associated with the related art have created a need for a system and method that overcomes these significant problems. The present invention addresses such problems by providing a solution that has not previously been proposed.

### SUMMARY OF THE INVENTION

The present invention presents a system that allows a professional service provider to send mass mailings of marketing materials to current clients and patients or potential clients and patients via a communications network. In addition to the tremendous marketing benefit provided by communicating electronically, there is a large potential costs savings. For example, the cost of designing and printing hardcopy marketing materials can be eliminated from the cost of the mailing. The cost of postage is also eliminated.

For example, one method as disclosed herein allows the professional service provider to create a communiqué and send it to a network based server. The server, in turn, may widely disseminate the communiqué to clients and potential clients that populate a database maintained by the server. This allows the professional service provider to communicate with a broad audience or a refined and specifically targeted group of recipients in an efficient, inexpensive manner.

Additionally, the scope of the present invention fully encompasses other embodiments that are recognizable to those skilled in the art, although such other embodiments may not be set forth in this summary description.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating an overview system architecture for network based marketing according to an embodiment of the present invention;

FIG. 2 is a block diagram illustrating an example server architecture for network based marketing according to an embodiment of the present invention;

FIG. 3 is a block diagram illustrating an example interface module according to an embodiment of the present invention;

FIG. 4 is a block diagram illustrating an example merge module according to an embodiment of the present invention;

FIG. 5 is a block diagram illustrating an example communication module according to an embodiment of the present invention;

FIG. 6 is a block diagram illustrating an example billing module according to an embodiment of the present invention;

FIG. 7 is a block diagram illustrating an example schedule module according to an embodiment of the present invention;

FIG. 8 is a block diagram illustrating an example reporting module according to an embodiment of the present invention;

FIG. 9 is a block diagram illustrating an example network marketing communiqué according to an embodiment of the present invention;

FIG. 10 is a block diagram illustrating an example network marketing client profile according to an embodiment of the present invention;

FIG. 11 is a flow chart illustrating an example process for providing network based marketing communiqués according to an embodiment of the present invention;

FIG. 12 is a flow chart illustrating an example billing process for network based marketing according to an embodiment of the present invention;

FIG. 13 is a flow chart illustrating an example tiered billing process for network based marketing according to an embodiment of the present invention;

FIG. 14 is a flow chart illustrating an example process for sending a personalized network based marketing communiqué according to an embodiment of the present invention;

FIG. 15 is a flow chart illustrating an example process for providing a network based marking report according to an embodiment of the present invention; and

FIG. 16 is a block diagram illustrating an exemplary computer system as may be used in connection with various embodiments described herein.

### DETAILED DESCRIPTION OF THE INVENTION

Certain embodiments as disclosed herein provide for a system and method for network based marketing. For example, one method as disclosed herein allows a professional service provider to create a communiqué and send it to a network based server. The server, in turn, may widely disseminate the communiqué to clients and potential clients that populate a database maintained by the server. This allows the professional service provider to communicate with a broad audience or a refined and specifically targeted group of recipients in an efficient, inexpensive manner.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

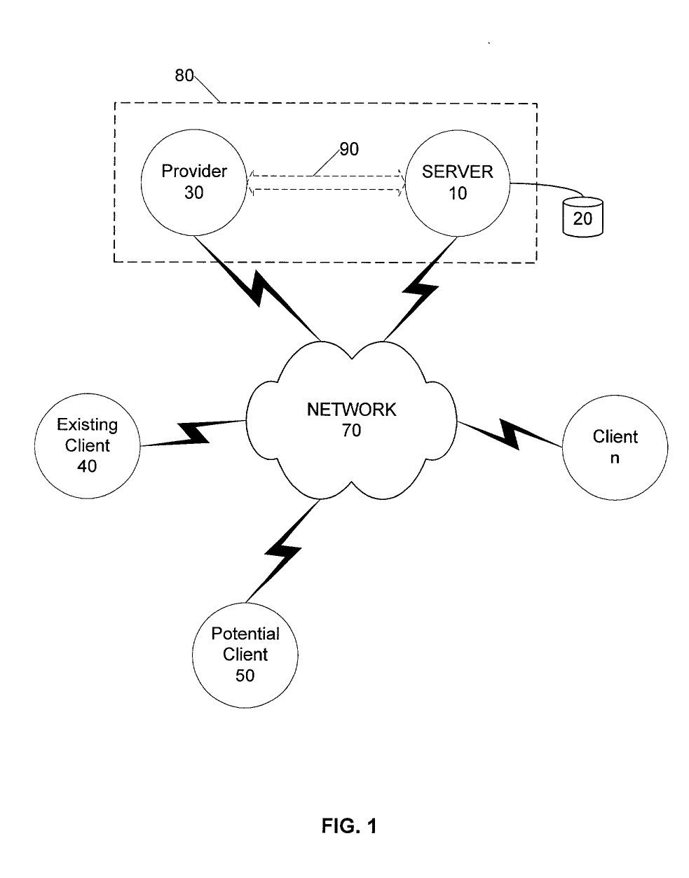

FIG. 1 is a block diagram illustrating an overview system architecture for network based marketing. The network based marketing system may be comprised of a server 10 connected to a database 20. The system may also be comprised of several clients, such as existing client 40, and potential client 50. Additional clients may also be included in the system, as indicated by client n. These additional clients may be existing clients or potential clients. Each of the clients is preferably communicatively coupled with the server 10 through network 70.

The system may also be comprised of a provider 30, communicatively coupled with server 10 through network 70. Provider 30 may also be in communication with server 10 through channel 90. Channel 90 may be a direct physical connection (cable), a logically programmed connection (socket), or a direct private connection such as a leased line or a secured dial-up modem connection. In an alternative embodiment, server 10 and provider 30 may be combined in a single device 80. In such an embodiment, the functionality of server 10 and provider 30 may advantageously remain separate while sharing the resources of device 80 such as persistent storage, memory, and processing power (not shown).

Network 70, preferably facilitates communication between server 10 and provider 30, existing client 40, client 50, and client 60. Additionally, network 70 may facilitate communication between server 10 and additional client(s) n. Furthermore, in an alternative embodiment, network 10 may provide communication directly between provider 30 and the various clients. Network 70 may be a proprietary network, a public network, a wide area network (“WAN”), a local area network (“LAN”), or a combination of networks, such as the well known Internet. Additionally, network 70 may be a wired network or a wireless network.

Network 70 preferably supports a variety of communication protocols such as TCP/IP, UDP, HTTP, FTP, SMTP, POP and the like. In one embodiment, communications between server 10 and the various clients may employ an electronic mail (“email”) format that is based on the SMTP communication standard or an extension of that standard, such as the ESMTP communication standard. Additionally, communications between server 10 and the various clients and providers may employ the HTTP communication standard.

Database 20 may be comprised of data germane to the operation of a network based marketing system. Database 20 may contain a plurality of records relating to clients, potential clients, colleagues, employees, financial transaction processors, vendors, and other types of entities that may be helpful to a network based marketing system. Database 20 may also be comprised of historical data such as transaction related information and information relating to the responses generated by previously sent communiqués. Database 20 may also be comprised of data relating the particular environment or system that comprises the network based marketing system 10. Furthermore, database 20 may be optimized to provide efficient storage, retrieval of data, and may also be configured to allow system 10 to collect information, distribute communiqués, and provide information. Database 20 may also be comprised of several logically or physically distinct distributed databases that are united by common normalization of the stored data and a common data retrieval scheme.

Additionally, database 20 may advantageously contain a plurality of prefabricated communiqués, attachments for communiqués, graphical images for inclusion in a communiqué, and the like. These various components of a communiqué can preferably be arranged and sorted by provider 30. For example, provider 30 may arrange the various attachments, insertions, etc. alphabetically, by file size, by file type, or by category. In one embodiment, provider 30 may sort the various components of a communiqué to more efficiently create the communiqué.

Database 20 may be populated with records from other database formats such as a complex database program like Microsoft Outlook® or simple text files maintained by a small business concern. These alternative format electronic compilations may be imported into database 20 in a fashion that overwrites the current records or appends the new records to the current records. Advantageously, database 20 may be configured to append only those new records that are not already present in database 20. Furthermore, database 20 may be configured to maintain a copy of the alternative format electronic compilation for possible later use in a recovery operation.

An additional function of database 20 can be to store file information relating to existing clients. For example, existing client 40 may be provided with secure, 24 hour access to her confidential legal or medical file information through system 10. This information may be very helpful in the event of an emergency that necessitates the services of a professional other than the existing client's 50 regular provider. For example, a medical emergency may require immediate access to an existing client's 50 files to provide historical medical information to an attending emergency physician.

In one embodiment, provider 30 may connect with server 10 over network 70. Once connected, provider 30 can create or identify a communiqué to be sent to a group of recipient clients, potential clients, or a combination of the two. Provider 30 can also designate the particular recipients. Upon completion of creating or designating the communiqué, server 10 may send the communiqué to each recipient via email, using network 70 as the transport mechanism.

In another aspect, potential client 50 may interact with server 10 over network 70. Advantageously, server 10 may present information tailored to the interests of potential client 50, as directed by potential client 50. For example, potential client 50 may connect with server 10 using the popular World Wide Web (“WWW” or “Web”) service that employs the HTTP protocol. As part of the interaction, potential client 50 may elect to request additional information. By completing and submitting a form supplied by server 10, potential client 50 can establish a record for herself in database 20. Advantageously, her record may be included in a particular folder that contains records of other clients and potential clients with like interests. This organization allows for future communiqués to be sent to potential client 50, benefiting both provider 30 and potential client 50.

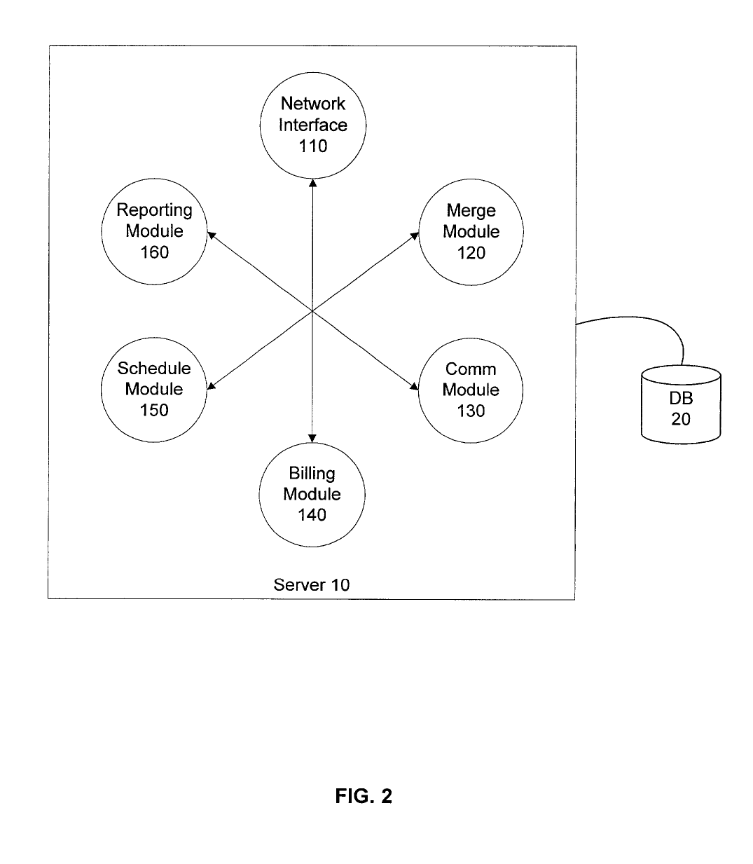

FIG. 2 is a block diagram illustrating an example server architecture for network based marketing. Server 10 is coupled with database 20 and comprises several components or modules. For example, server 10 can include a network interface 110, merge module 120, communication module 130, billing module 140, schedule module 150, and a reporting module 160. The modules and components that comprise server 10 may advantageously communicate with each other to facilitate the operation of system 10.

For example, network interface 110 may provide the communication interface with professional service providers and clients. Merge module 120 may communicate with database 20 to retrieve a list of recipients and then create individualized communiqués for each recipient. Communication module 130 may send communiqués out to recipients while billing module 140 may keep track of the number of communiqués sent and generate bills or invoices. Schedule module 150 may manage a schedule of appointments and reminders in addition to keeping track of client related dates such as birthdays and anniversaries. Finally, reporting module 160 may compile reports for system 10 and for professional service providers that portray information about the operation of the system, the success rate of its activities, and billing status.

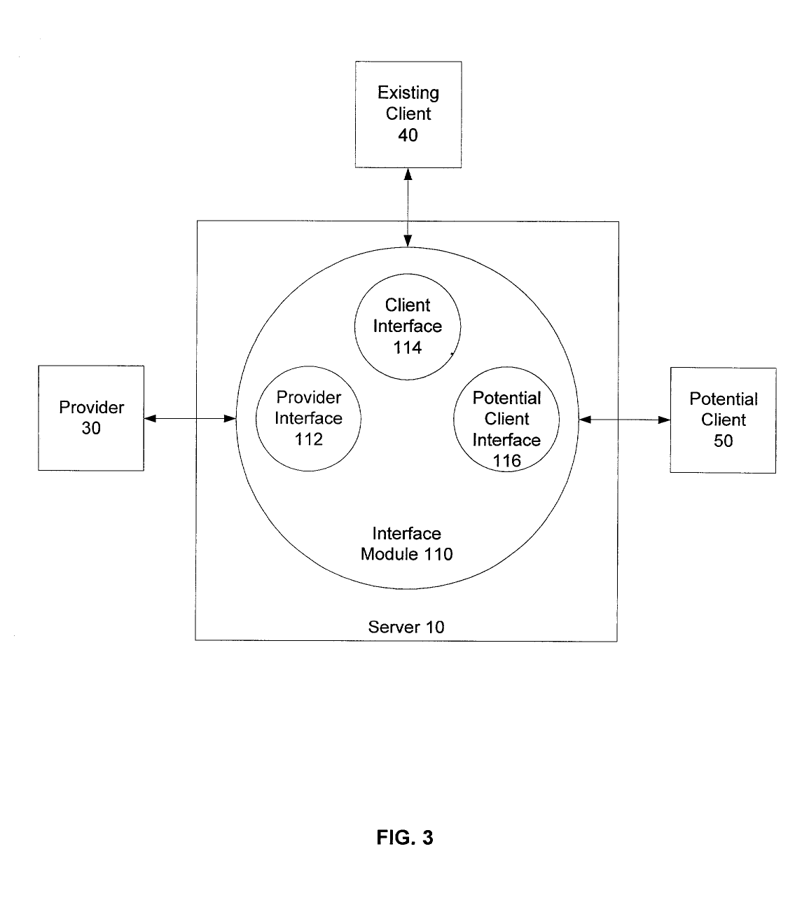

FIG. 3 is a block diagram illustrating an example interface module 110 included with server 10. Interface model 110 may be comprised of an provider interface 112 a client interface 114, and a new client interface 116. In one embodiment, interface module 110 may interact with provider 30, existing client 40, and potential client 50 using a Web browser interface that employs the HTTP protocol and the HTML language. An existing client may be defined as an individual that has previously received some sort of service from provider 30. Every other individual, with the attendant various levels of interest in the particular service offered by provider 30 can be defined as a potential client.

In one embodiment, interface module 110 may require authorization information prior to provided access to an entity contacting server 10 over the network. For example, authorization information may include an identifier and password combination. The identifier may be a number, such as a social security number, or it may be a word, such as a last name. Alternatively, the identifier may be an alpha-numeric combination of letters and numbers that identifies the entity. Preferably, the password is also an alpha-numeric combination, although in certain embodiments it may be alpha only or numeric only.

Provider interface 112 provides a professional service provider the ability to communicate with server 10 and create or identify the communiqué to be sent to a group of recipients. The professional service provider may create a communiqué by typing in the text of the communiqué or supplying the content in a similar fashion, for example uploading the content data from provider 30 to server 10. Alternatively, for content data that is already present on server 10, the professional service provider may identify the content for the communiqué by selecting the desired file or group of files.

Additionally, a professional service provider 30 can add new clients or potential clients to the database through provider interface 112. Moreover, the professional service provider can maintain the information contained in the database through provider interface 112. For example, the professional service provider may delete certain profiles in the database or make changes to certain profiled in the database. In one embodiment, the professional service provider may change core data for a profile, such as name and address information. Alternatively, the professional service provider may change industry specific information for a profile, such as appointment dates and drug prescriptions for a medical related industry or court dates and presiding court officers for a legal related industry.

Furthermore, a professional service provider 30 may also review billing reports, status reports, marketing reports, client and potential client groupings, and other information and reports through provider interface 112. For example, provider 30 may connect to server 10 through provider interface 112 and request to view a statement for the previous month's billing cycle. Alternatively, provider 30 may request to see a list of all existing and potential clients that are included in the laser eye surgery folder. Preferably, provider interface 112 facilitates the requests for and dissemination of this type and other types of information.

Client interface 114 provides an existing client 40 the ability to browse through information that is of interest to existing client 40 and perhaps related directly to existing client 40. For example, existing client 40 may have the ability to peruse her legal, medical, dental, or other type of provider file while communicating with server 10 through client interface 114. Furthermore, client interface 114 may allow existing client 40 to view materials that are particularly germane to the interests of existing client 40. In one embodiment, client interface 114 may provide existing client 40 access to materials related to eye surgery, a procedure indicated by existing client 40 as of interest.

Potential client interface 116 may provide potential client 50 with access to information maintained by server 10. For example, potential client 50 may obtain information related to eye surgery. In one embodiment, the information received by potential client 50 relating to eye surgery may be more general than the information received by existing client 40 through client interface 114. For example, existing client 40 may have an astigmatism and may therefore advantageously receive information relating to eye surgery that is tailored for a patient with an astigmatism. On the other hand, potential client 50 preferably receives general information relating to eye surgery.

Potential client interface 116 additionally provides potential client 60 the ability to supply the information necessary to receive future marketing communiqués or other types of informational communiqués. For example, a form within potential client interface 116 can be presented to potential client 50 who is browsing information provided by server 10. Potential client 50 can complete the form by providing certain core data information, such as name, address, age, interests, medical history, etc. to be stored in a data storage area on server 10. Preferably, the information is stored as a client profile record, thereafter allowing potential client 50 to be known to server 10 during future connections.

One particular advantage of potential client interface 116 is the ability to populate fields in the client profile record based on the navigation history between potential client 50 and potential client interface 116. For example, potential client 50 may navigate through certain information made available by server 10. During the course of potential client's 50 navigation, potential client 50 may review eye surgery information and in particular, information about laser eye surgery. Additionally, potential client 50 may review information related to breast augmentation and specifically pertaining to surgical implants for cosmetic augmentation. Advantageously, potential client interface 116 may use the navigation history information to include indicators of the potential client's 50 interest in the client profile record created.

In one embodiment, the navigation history information may be used by server 10 to include the newly created client profile record in certain predefined folders that facilitate the delivery of information to existing and potential clients with particular interests. For example, a client profile record for a existing or potential client that has expressed an interest in laser eye surgery may be included in a folder that groups together those existing and potential clients with an interest in laser eye surgery. Similarly, if the same client has expressed an interest in breast augmentation, then the client profile record may also be included in a folder dedicated to breast augmentation. Advantageously, a single client profile record may be included in a plurality of interest folders, while only a single copy of the record is maintained in the database.

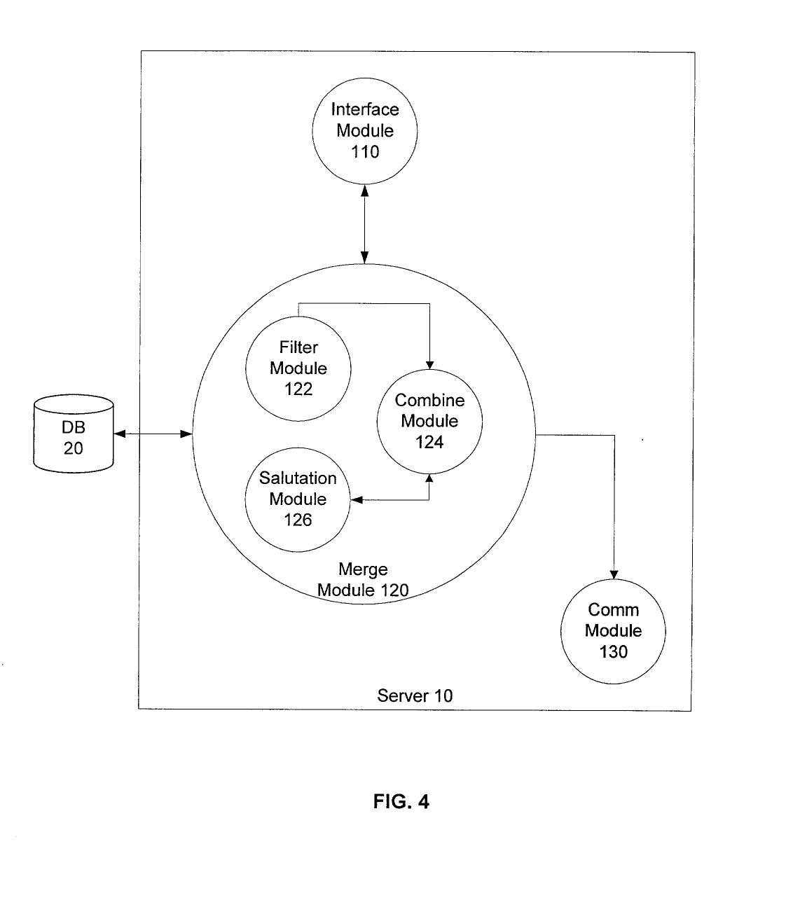

FIG. 4 is a block diagram illustrating an example merge module 120 communicatively coupled with interface module 110 and communication module 130. Interface module 110, merge module 120, and communication module 130 are all resident within server 10. Additionally, merge module 120 is in communication with database 20. Client profile records for a plurality of clients are preferably stored in database 20.

In one embodiment, merge module 120 may receive a communiqué from interface module 110. Accompanying the communiqué, or included as part of the communiqué, may be a list of recipients or a set of criteria that define a list of recipients. The list of recipients may comprise a plurality of client profile records that are preferably stored in database 20. Merge module 120 may merge the communiqué received from interface module 110 with each client profile record contained in the list of recipients, to create a separate communiqué for each client profile record. Each separate communiqué may then be sent to communication module 130 for processing and ultimate delivery to the client.

Furthermore, merge module 120 may be comprised of filter module 122, combine module 124, and salutation module 126. In one embodiment, filter module 122 may receive the list of recipients from interface module 110. Alternatively, filter module 122 may receive from interface module 110 the set of criteria defining the list of recipients. Filter module 122, once it has received the set of criteria, filters the client profile records in database 20 to obtain the list of recipient client profile records that match the set of criteria provided by the interface module. Upon receiving the list of recipient client profile records, filter module 122 passes the list of records to combine module 124.

Salutation module 126 contains a set of criteria that defines how the communiqué is addressed. For example, a communiqué may be individually addressed by various salutations such as Dear [First Name], or alternatively Dear [Mr.|Ms.|Mrs.] [Last Name]. Such salutations might ultimately become Dear Frank, or Dear Mr. Robbins. Other salutations may be Dear Sir, Dear Madam, and Dear Sir or Madam. Various additional salutations may also be used, some of which may be provided for selection by salutation module 126 and others that may be supplied by a service provider. For example, salutation module 126 preferably allows a service provider to customize the salutation that is to be used with a particular communiqué. In one embodiment, a service provider may select the salutation from a list or supply a custom salutation.

Combine module 124 receives the list of recipient client profile records, extracts the email address from each record, and addresses the communiqué to the email address for each client in the list of recipient client profile records. Each addressed communiqué is then prefixed with the appropriate salutation. Combine module 124 obtains the salutation by consulting salutation module 126, which provides combine module 124 with the salutation to be used. Each addressed and prefixed communiqué is then sent from combine module 124 to communication module 130 for ultimate delivery to the client.

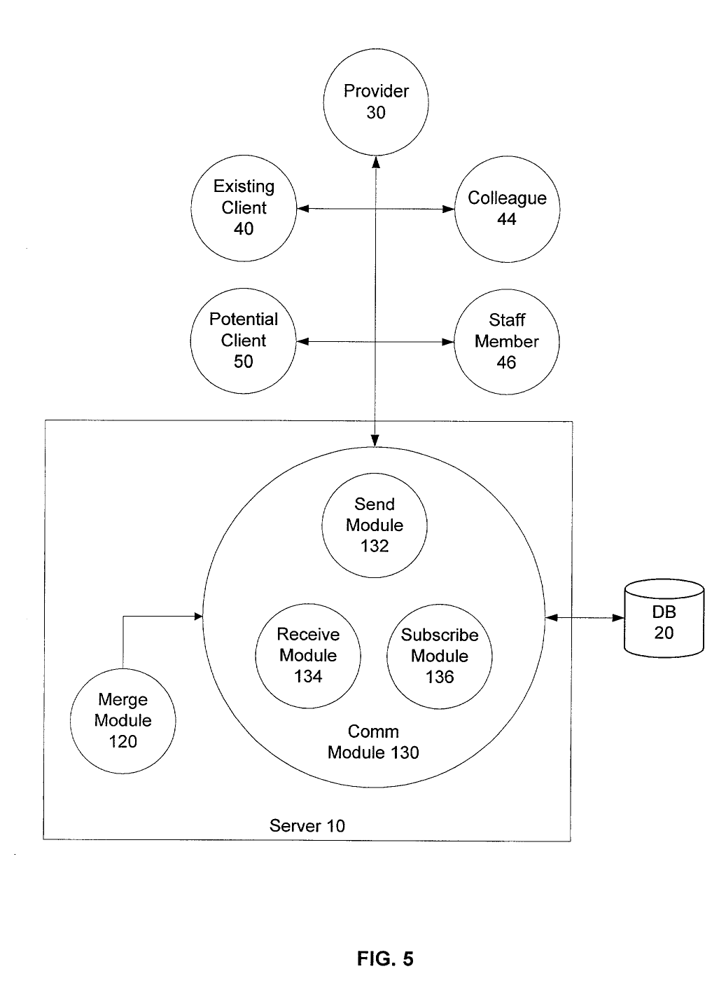

FIG. 5 is a block diagram illustrating an example communication module 130 communicatively coupled with merge module 120 within server 10. As described above with reference to FIG. 4, communication module 130 receives a plurality of communiqués, each combined with the email address of the recipient client. Upon receipt, communication module 130 sends each communiqué to the appropriate client. Preferably, the communiqué is sent to the recipient client via an email service. Alternatively, the communiqué may be sent to the recipient client via various other delivery methods including, but not limited to: wireless SMS, HTTP, FTP, and rcp (remote copy), just to name a few.

Additionally, communication module 130 can send the communiqué to a plurality of recipients not limited to clients. For example, a communiqué may be directed to existing client 40, and potential client 50. Furthermore, communication module 130 may send a communiqué to colleague 44, staff member 46, or provider 30. In one embodiment, the service provider may be a professional, such as a doctor. For example, the doctor may employ server 10 to send a description of a new surgical technique invented by the doctor to a group of the doctor's contemporary colleagues. Additionally, the doctor may employ server 10 to send to his or her staff a memorandum outlining office policy or updating the holiday schedule, for example.

Communication module 130 may be comprised of a send module 132, a receive module 134, and a subscribe module 136. Send module 132 may be used by communication module 130 to send communiqués to those recipients identified by the service provider. Send module 132 may also be used to send acknowledgements or other communications to peer modules within server 10.

Receive module 134 may be used to receive communiqués sent from merge module 120 or acknowledgements sent from the various recipients of a communiqué such as existing client 40, potential client 50, colleague 44, staff member 46, or provider 30. In one embodiment, receive module 134 may receive a response to a communiqué from a recipient. For example, a communiqué delivered by email may provide a recipient with the ability to reply to the email in a fashion that submits a request to server 10 to remove the particular recipient from the mailing list. Such a reply may be constructed so that it is sent to server 10 for receipt by communication module 130, and more particularly, receive module 134.

Importantly, this type of “unsubscribe” reply capability can exist in addition to the ability for a provider to customize the “reply-to” address for a communiqué sent via email. For example, a customized “reply-to” address preferably allows the service provide to specify the email address that receives any replies to the communiqué. Alternatively, the “unsubscribe” ability allows a recipient to send an email request that the recipient be removed from the particular mailing list that generated the communiqué. In one embodiment, the recipient may also be able to request removal from all mailing lists for the particular service provider.

Subscribe module 136 advantageously receives such “unsubscribe” replies from receive module 134. Once subscribe module 136 receives the reply, the reply may be parsed to determine if the recipient wishes to be removed from a particular mailing list or all mailing lists for the particular service provider. Subscribe module 136 preferably access the existing or potential client profile record in database 20 and modify the record accordingly.

In an alternative embodiment, subscribe module 136 may consult the list of recipients for a particular communiqué and ensure that each client profile record in database 20 is appropriately designated as a member of the particular mailing list. Advantageously, in this fashion, subscribe module 136 may keep up-to-date the particular mailing lists that are used by a service provider.

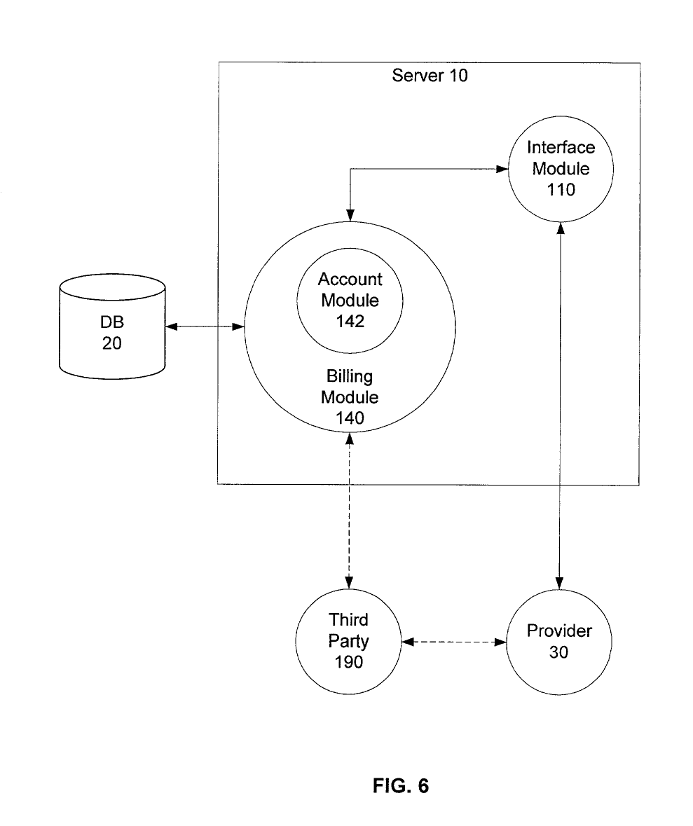

FIG. 6 is a block diagram illustrating an example billing module 140 communicatively coupled with an interface module 110 within server 10. Billing module 140 is also communicatively coupled with database 20. In one embodiment, billing module 140 can be communicatively coupled with a third party 190, which may perform various functions related to a network based marketing system. Provider 30 can also be communicatively coupled with interface module 110 as previously described with reference to FIG. 3.

For example, provider 30 may connect to server 10 through interface 110 and request information from billing module 140. The information requested from billing module 140 may require data stored in database 20. Billing module 140 may then query database 20 to retrieve the necessary information, construct the presentation of the information, and deliver the information to requesting provider 30 through interface 110. Preferably, a plurality of various predefined and customizable billing reports are available to provider 30 through interface module 110. In one embodiment, a billing report may present a base fee or monthly fee charged to provider 30 and may also present a per transaction fee charged to provider 30. Furthermore, a billing report may present how much credit provider 30 has to apply to future communiqués and future transactions.

In an alternative embodiment, billing module 140 may automatically generate a billing report that is sent to third party 190 for processing. Third party 190 may be a financial clearinghouse, a credit card company, a collection agency, a financial institution, or some other entity that receives the billing report or statement from billing module 140 and processes the statement is a fashion that balances the statement with funds from provider 30. For example, third party 190 may be a credit card company that receives the billing statement from billing module 140. Third party 190 may then pay the balance reported on the billing statement and also bill provider 30 the same amount. Subsequently, provider 30 may pay third party 190 (e.g. the credit card company) in the normal course of business for thirdparty 190.

In another embodiment, provider 30 may prospectively pay for the network based marketing services offered by server 10. For example, provider 30 may contact third party 190 and purchase the services offered by server 10. The services purchased may be a block of emails, for example, 10,000 email marketing pieces. The services may be offered in blocks of numbers, or in blocks of numbers of certain types of pieces. For example, provider 30 may purchase a block of birthday cards, a block of appointment reminders, or perhaps a block of communiqués that contain audio and visual, moving picture type content. Additionally, provider 30 may pre-pay a monthly base fee charged for the network based marketing service.

Once the network based marketing services have been purchased by provider 30, third party 190 can then notify billing module 140 of the purchase. In such an embodiment, third party 190 can be a sales representative, a middle market provider, or an authorized reseller. The notice that third party 190 provides to server 10 can advantageously serve as a credit for provider 30. Future communiqués sent by provider 30 may then be offset against the prospectively paid for credit purchased by provider 30.

Additionally, billing module 140 may include account module 142. Account module 142 preferably facilitates the maintenance of the system account for provider 30. Various administrative and configuration finctions may be provided by account module 142. For example, account module 142 may provide the ability to configure the colors available to provider 30, the number of characters per communiqué, the number of images per communiqué, the amount of disk space available to provider 30, the password, the number of images that can be uploaded by the provider, and the size, type, and number of any attachments to communiqués.

In one embodiment, third party 190 may be an account administrator or a sales representative. The account administrator or sales representative may communicate with server 10 through account module 142 to configure the abilities of provider 30. Additionally, account module 142 may preferably be integrated with billing module 140 to provide billing characteristics for the provider's 30 account. Such billing characteristics may include the amount of disk space used, the number of images uploaded to server 10, and the maximum number of attachments available per communiqué, just to name a few.

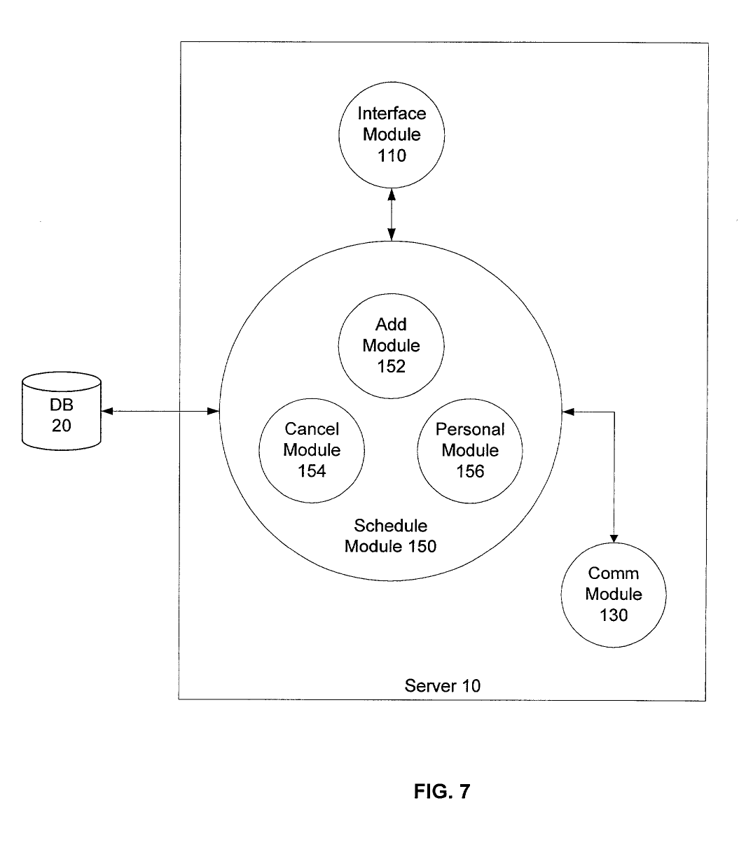

FIG. 7 is a block diagram illustrating an example schedule module 150 coupled with an interface module 110 and a communication module 130 within server 10. Furthermore, schedule module is communicatively coupled with database 20. Schedule module 150 may also be comprised of an add module 152, a cancel module 154, and a personal module 156. In one embodiment, the function of schedule module 150 may be to maintain a schedule of appointments for a plurality of clients with client profile records stored in database 20. Furthermore, schedule module 150 may manage the schedule or calendar of a professional service provider such as a doctor or lawyer.

For example, schedule module 150 may manage an appointment calendar for a doctor. Various clients, staff, colleagues, and even the doctor herself may access schedule module 150 through interface module 110. Upon accessing schedule module 150, entries in a calendar or schedule (e.g., an appointment) may be added, deleted, or modified. Advantageously, this information can be maintained in persistent storage in database 20.

In one embodiment, an add module 152 may be employed to add entries or requests within schedule module 150. For example, a client or colleague may request through interface module 110 that an appointment be scheduled. That request may advantageously be directed to add module 152 within schedule module 150. Add module 152 may then request schedule information from database 20 to determine if the requested appointment can be scheduled. The add module 152 may then tentatively schedule the appointment or confirm the scheduled appointment. For example, add module 152 may consult a set of rules established by the doctor to determine whether an appointment can be confirmed or tentatively scheduled.

Similarly, a cancel module 154 may be employed to cancel entries or requests within schedule module 150. For example, a client or colleague may have an appointment that is already scheduled within schedule module 150. The client or colleague may thereafter communicate with schedule module 150 through interface module 110 and elect to cancel the previously scheduled appointment. The cancel module 154 may receive the request to cancel the appointment and then modify, accordingly, the schedule data maintained in database 20 by schedule module 150. Furthermore, the cancel module 154 may also be configured to notify each party involved in a scheduled event when that particular even is cancelled.

In one embodiment, the schedule module 150 may employ a personal module 156. The personal module 156 may consult and review the data in database 20 to determine when clients, colleagues, and other entities with records in database 20 have upcoming appointments, special events, or anniversary events. For example, the data associated with a single client profile record may include that client's next appointment in addition to storing the data of that client's birthday. Prior to the client's appointment or birthday, the personal module 156 may determine that the appointment or birthday is near. Once determined, the personal module 156 may construct and send, on behalf of the doctor, a reminder notice for the appointment or a greeting card in honor of the patient's birthday or other special holiday.

Preferably, when any changes are made to the schedule data maintained in database 20, schedule module 150 initiates a message that is forwarded to communication module 130 for ultimate delivery to the client or colleague or professional service provider that may be affected by the schedule change. Additionally, when an appointment, greeting card, or holiday message is generated by personal module 156, the schedule module 150 preferably forwards that message to communication module 130 for ultimate delivery to the respective client or colleague.

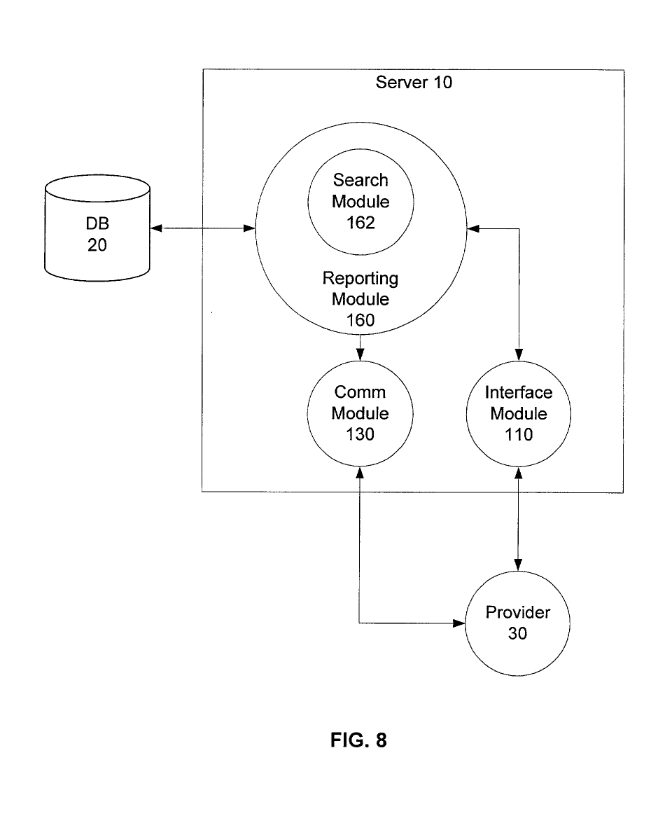

FIG. 8 is a block diagram illustrating an example reporting module 160 communicatively coupled with an interface module 110 and a communication module 130 in a server 10. Additionally, reporting module 160 is in communication with a database 20. Database 20 preferably stores and maintains historical data relating to the services and operation of a network based marketing system operated by system 10. A professional service provider may also be present and be in communication with server 10 through interface module 110 and communication module 130.

Reporting module 160 preferably accesses data from database 20 and configures the data into a plurality of various reports. Reports can include information relating to the sending and receiving of marketing communiqués, responses to marketing communiqués, and requests for additional information resulting from the receipt of a marketing communiqué. Additional reports may present information related to the uptime of system 10, the number of hits received by a professional service providers web page, and other various information related to the operation of a network based marketing system and the business of the client's subscribing to the services of system 10.

In one embodiment, provider 30 may connect to system 10 through interface module 110 and provide customized requests to reporting module 160. Alternatively, the requests provided by provider 30 may be requests for standard reports made available by reporting module 160. Upon receiving the request for a standard or custom report, reporting module 160 queries database 20 for the relevant information, compiles the report, and delivers the report to interface module 110 for display to provider 30.

In an alternative embodiment, certain timely reports may be automatically generated by reporting module 160. In such an embodiment, the reporting module 160, at the appropriate time, may obtain the necessary information from database 20, compile the report, and forward the report to communication module 130 for ultimate delivery to provider 30. For example, a monthly report may be sent to provider 30 on the last day of each month. At the close of business on the last day of a month, reporting module 160 may request all data related to the network based marketing activities of provider 30 for the past month. Database 20 may provide the requested information to reporting module 160, where the information is compiled into a user friendly display format. Subsequently, reporting module 160 may forward the compiled monthly report to communication module 130 for ultimate delivery to provider 30.

Additionally, reporting module 160 may include search module 162. Search module 162 may advantageously allow provider 30 to search for client profile records in database 20 based on certain criteria. For example, provider 30 may supply certain criteria to search module 162. Subsequently, search module 162 may consult database 20 to determine the set of client profile records that match the criteria supplied by provider 30. Examples of criteria that can be supplied by provider 30 include, but are not limited to: names, birthdays, addresses, phone numbers, and special interests, just to name a few. Furthermore, any category or data point contained in database 20 may be employed by provider 30 and search module 162 to locate a desired client profile record.

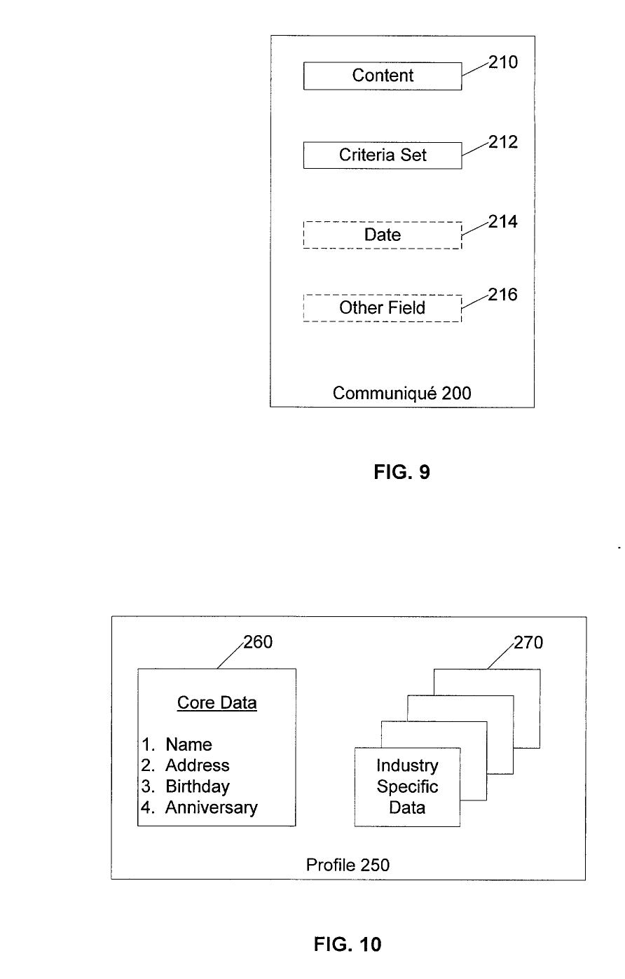

FIG. 9 is a block diagram illustrating an example communiqué 200 for use in a network marketing system. A communiqué may be comprised of content 210, a criteria set 212, a date 214, and various other fields 216. Preferably, the date 214 and other 216 fields can be optionally included in a complete communiqué 200.

Content 210 may itself be comprised of various types and formats of information and data. For example, content 210 may include basic text, hyper links, graphical, and audiovisual components. In one embodiment, content 210 may contain a practice update for a professional service provider such as a doctor or lawyer. Alternatively, content 210 may contain a birthday card, holiday greeting, a thank you card, and a signature block indicating the sender, just to name a few types of information that can be included. Content 210 may also contain URLs or pictures/graphics that are linked to various web pages.

Criteria set 212 may define a particular set of client profile records that are maintained in a database connected to the network based marketing server system. These defined client profiles may identify the clients, colleagues, or other that are intended recipients of the communiqué 200. For example, a criteria set may define all clients and potential clients that have expressed an interest in laser eye surgery. Alternatively, a criteria set may define all colleagues that perform laser eye surgery. Another possible criteria set may define all of the staff people associated with a professional service provider who is the professional service provider sending the communiqué 200.

The date 214 may be in various well know formats for dates. The function of the date 214 may advantageously allow the professional service provider to tender a communiqué 200 to the network based marketing system that is to be delivered at some point in the future. That point in the future is preferably identified by the date 214 field that is included with the communiqué 200. In one embodiment, the date 214 field 214 may be optionally included in communiqué 200.

Various other 216 fields may also be optionally included in communiqué 200. For example, a return email address field may advantageously be included. A particular advantage of a return email address field is that it may allow the sender to redirect any reply emails to a particular email address. One example might be for the professional service provider to create the communiqué 200 and include a return email address field in order to have any replies to the communiqué 200 delivered to the professional service provider's assistant. Additionally, the other 216 field may be used to indicate a particular signature block that is to be included with the communiqué 200. This can allow the professional service provider to have various closing text and graphics blocks stored on the network based marketing system. The particular block to be included with communiqué 200 can then be identified with an other 216 field that is part of the communiqué 200. Various other fields advantageous to a network based marketing system will be apparent to those having ordinary skill in the art and are therefor not mentioned here for the sake of brevity.

FIG. 10 is a block diagram illustrating an example network marketing client profile 250. The client profile 250 can be comprised of certain core data 260 and one or more data blocks 270 containing industry specific data. A single client profile may represent a patient, a colleague, a staff member, or any other type of individual that is advantageously included in the database for a network based marketing system. For example, a doctor's patient and a lawyer's client may each have a profile 250 in the database. Similarly, a doctor's nurse or a lawyer's paralegal may each have a profile 250 in the database, in addition to the doctor herself and the various colleagues of the doctor.

Furthermore, the database advantageously only maintains a single copy of a profile 250, although the profile 250 may be present in a plurality of views or folders in the network based marketing system. For example, a single patient may be part of a laser eye surgery folder and a Vicodin® prescription folder. However, the patient, although appearing in a plurality of different folders, advantageously has only a single profile 250 in the database.

In one embodiment, core data 260 may include certain attributes such as the name of the client, address, birthday, spouse name, anniversary, children's names and dates of birth, and a variety of additional information relating to the client. Core data 260 can additionally contain demographic information that helps to identify the client through the use of a criteria set. Advantageously, this allows a professional service provider creating a communiqué to accurately describe the client by identifying the appropriate data elements that are contained in core data 260.

Alternatively, data blocks 270 may contain industry specific data that may further identify or differentiate a profile 250. For example, one data block 270 may include data elements that are germane to laser eye surgery such as date of the surgery, type of medicine prescribed, pre-surgery vision assessment, post-surgery vision assessment, and other information that is relevant to laser eye surgery. An additional data block 270 that may be associated with profile 250 can be for breast augmentation surgery. Data elements that might be included with such a data block 270 might include date of surgery, type of insert, breast size prior to surgery, breast size after surgery, blood type, weight of patient, and type of anesthesia used in surgery, just to name a few.

FIG. 11 is a flow chart illustrating an example process for providing network based marketing communiqués. Initially, in step 280 the server machine operating the network based marketing system receives a set of criteria defining the characteristics of the recipients of the communiqué. For example, a set of criteria might require that each recipient have had laser eye surgery or some other type of personal service. Alternatively, the set of criteria might include a requirement that each recipient be male and in a particular age range. In one embodiment, the set of criteria might include a requirement that each recipient be currently taking the prescribed drug Vicodin®.

Once the set of criteria has been received, the server can filter the database of profiles to retrieve only those profiles that meet the supplied criteria, as illustrated in step 282. The filter process, in one embodiment, may be carried out by sending a query to a database comprising a plurality of profiles. The query may advantageously be constructed of the supplied criteria. The results of the query is preferably a filtered subset of the profiles in the database.

In addition to receiving the criteria identifying the set of clients to receive the communiqué, the network based marketing server also receives the content of the communiqué, as shown in step 284. The content of the communiqué can include text, hyper links, graphics, audio, and moving picture video, to name just a few options. The content can be received in full, or an identifier to content that already exists in persistent storage on the server may be used.

In step 286, the server creates an individualized communiqué to be delivered to each recipient identified by the supplied criteria. For example, the communiqué may be prefixed with a salutation such as “Greetings John,” where John is the first name of the client, as described in the client profile. Furthermore, the communiqué may be personalized by addressing the communiqué to be delivered to the email address for each respective client in the recipient list.

Finally, the network based marketing server sends out each separately addressed and individualized communiqué to its respective recipient, as illustrated in step 288. Preferably, the server employs an email distribution strategy for its delivery mechanism. Alternatively, each communiqué may be delivered to the recipient via alternative delivery methods such as, for example, ftp and rcp.

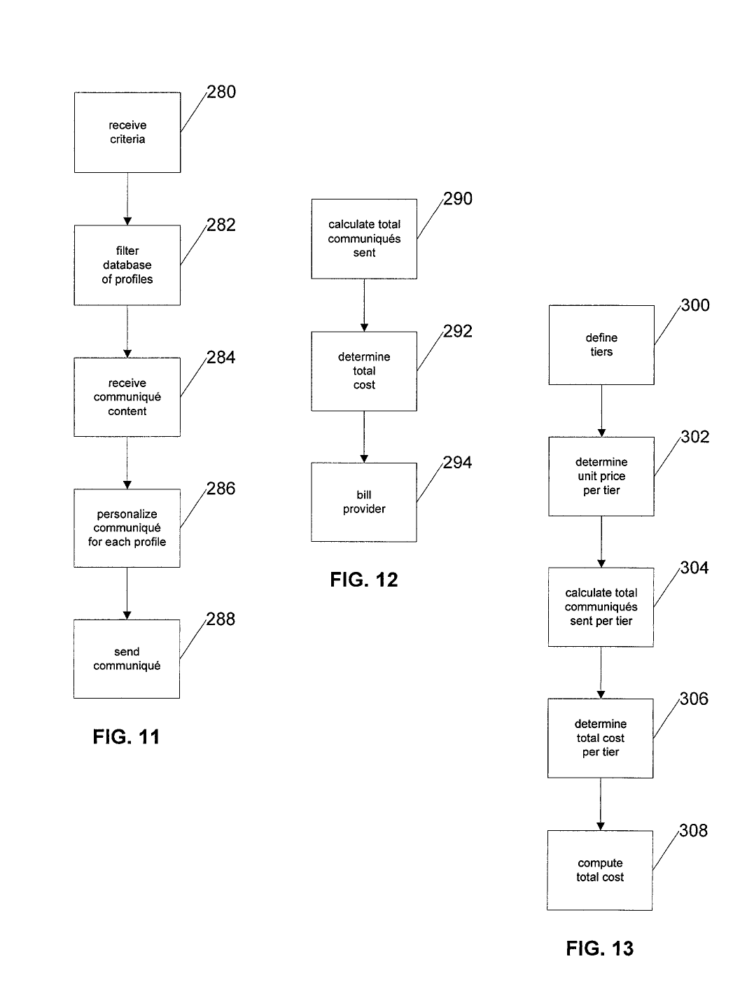

FIG. 12 is a flow chart illustrating an example billing process for network based marketing, according to an embodiment of the present invention. In step 290, the network based marketing server calculates the total number of communiqués sent. Preferably, the total number of communiqués tabulated are for a single particular professional service provider, who may be a professional service provider such as a doctor, lawyer, dentist, or other type of professional service provider. To identify the total number of communiqués sent, the server may, in one embodiment, query the database to determine the total number of communiqués sent on each day that comprises the billing period. For example, each day in a calendar month may comprise a standard billing period. The aggregate of the total number of communiqués sent on each day may then be computed by the server.

Once the total number of communiqués sent has been calculated, the server next can compute the total cost, as illustrated in step 292. The total cost may be computed by multiplying a cost per communiqué by the total number of communiqués sent. Alternatively, the total cost may be determined by computing a total cost and then subtracting a discount for bulk usage or a discount applied to the account for various other reasons. Many other methods of computing a total cost for all communiqués and discounting that cost will be evident to those with ordinary skill in the art and are therefore not fully discussed herein.

Once the total cost for the total number of communiqués sent has been determined, a bill can be sent to the provider of the communiqués for subsequent remittance, as shown in step 294. Preferably, the sender is a professional service provider who may be a professional service provider such as a doctor, lawyer, dentist, or other as described above.

FIG. 13 is a flow chart illustrating an example tiered billing process for network based marketing. A tiered billing process may be employed when the cost per communiqué varies according to a schedule. For example, a tiered schedule may impose a certain price per communiqué for the first 5,000 communiqués sent. That price per communiqué would define the first tier. A second tier may be defined by imposing a lesser price per communiqué for each communiqué sent between 5,000 and 15,000. Similarly, a third tier may be defined for those communiqués sent between 15,000 and 50,000. Thus the described three-tier system would have a billing process with three different prices per communiqué.

Initially, a tiered billing process can establish or define the tiers to be used, as illustrated in step 300. Next, the unit price per tier may be established, as shown in step 302. Once the prices have been established, the total number of communiqués sent for each tier can be determined, as seen in step 304. When determining the total number of communiqués sent for each tier, the system may advantageously first determine the total number of communiqués sent. When the total number sent falls into the second or third tier, the total number sent for the first tier need not be calculated, as it will be equal to the total number of units for that tier.

Once the total number of communiqués sent per tier has been determined, the total cost per tier is calculated, as shown in step 306. Advantageously, the total cost per tier for each tier that has been completely filled may not need to be calculated since that value may be predetermined by multiplying the total number of units per tier times the unit price for that tier. For the final tier, the total number of communiqués sent within that tier can be multiplied by the unit price for the tier to determine the total cost for that tier.

After the total cost for each tier has been determined, the system computes the total cost for the tiered billing process, as illustrated in step 308. For example, the system can calculate the sum of the total cost value for each tier to determine the total cost. This total cost may then be passed along to the sender in the remittance process previously described with reference to FIG. 12.

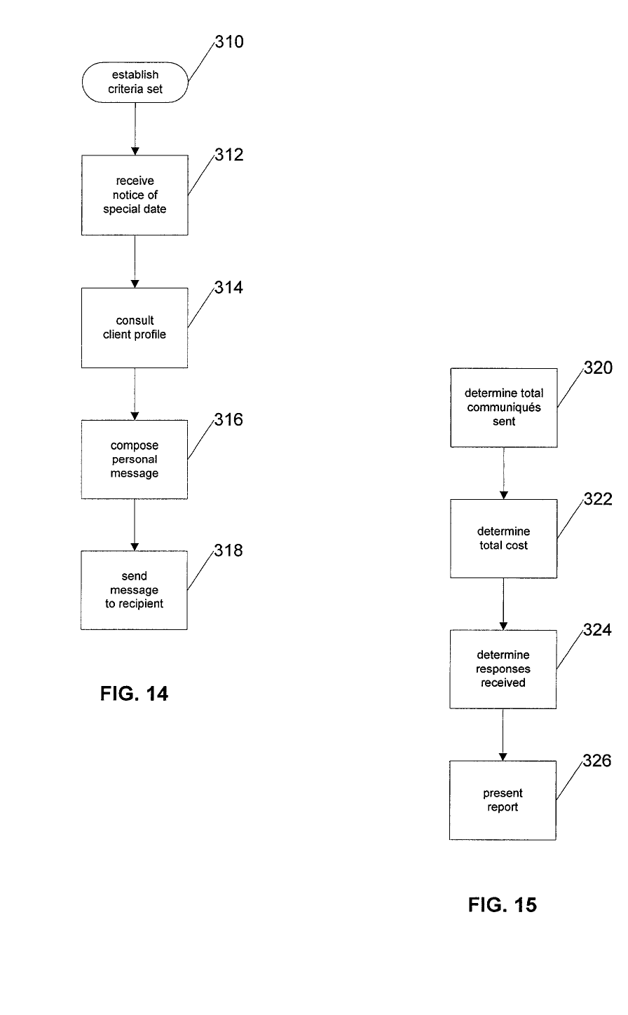

FIG. 14 is a flow chart illustrating an example process for sending a personalized network based marketing communiqué. Initially, in step 310, a content criteria set may be established that allows the system to determine the message content of the personalized communiqué. For example, the content criteria set may require that male recipients of a personalized communiqué receive an image of a race car included with the communiqué while female recipients receive an image of flowers. Alternatively, the content criteria may suggest different language to be used based on the age of the recipient. In one embodiment, the message content may differ for existing clients that have received particular services, such as plastic surgery, laser eye surgery, legal defense, or the like. After the content criteria have been set, the process for sending a personalized communiqué remains the same, and step 310 may be excluded. However, at any time, step 310 may be included to modify the criteria set according to the wishes of the service provider.

Once the content criteria have been set, the server receives notice of an identified event, as illustrated in step 312. For example, an identified event can be a birthday, anniversary, or a holiday that is personal to a particular client. Additionally, an identified event can be an appointment reminder that notifies a client of an upcoming appointment. In one embodiment, an appointment reminder can be sent to a client several times prior to the appointment date. For example, a reminder can be sent 10 days in advance, 5 days in advance, and 1 day in advance.

The date of the event or upcoming event may be determined by maintaining a calendar of events that is consulted by a component of the system. When an event or reminder is scheduled, the system is notified. In the example where the event is a personal event such as a birthday, once notice of the birthday event is provided to the system, the client profile record for the recipient client is consulted, as shown in step 314. The client profile record is consulted to determine the applicable criteria settings for the particular client. For example, according to the established criteria set, it may be necessary to determine the sex of the particular recipient client.

Once the client profile record has been consulted, a personal message to that client may be composed, as seen in step 316. The personal message can be directed to the client, preferably using the client's name to make the message more friendly. Additionally, the personal message may be tailored to suit the particular holiday. For example, the message may say “Happy Birthday” or “Happy Anniversary” depending on the type of event.

Once the personal message has been composed, the message is sent to the recipient, as shown in step 318. Preferably, the message can be sent to the recipient via email. In an alternative embodiment, the message may be delivered to the recipient via ftp or rcp. In one embodiment, an email message may be delivered that contains a link to the personalized content, which may comprise a web page that can include audio, graphics, moving pictures, and text.

FIG. 15 is a flow chart illustrating an example process for providing a network based marking report. Reporting capabilities can be desirable for a system that implements a network based marketing strategy. For example, reports may inform a professional service provider who uses the system of current billing activity. Additionally, reports may inform the professional service provider of the success of her marketing communiqués. For example, a report may detail how many communiqués were sent and how many clients and potential clients affirmatively responded. Furthermore, a report may detail how much interest is being generated by the professional service provider's personal or business web page.

In one embodiment a report can be generated by first determining the total number of communiqués sent, as illustrated in step 320. Once the total number of communiqués sent has been determined, the total cost for sending the communiqués can be computed, as seen in step 322. Additionally, a total number of affirmative responses can be determined, as shown in step 324. An affirmative response can be determined by including an appropriately created link in the communiqué so that a client that clicks on the link is presented with the desired material and a record of the affirmative response is stored at the server. Finally, a report may be generated that includes the total number of communiqués sent, the total cost for sending the communiqués, and the total number of affirmative responses received from the communiqués, as illustrated in step 326. This type of reporting may advantageously educate the professional service provider (who may be a professional service provider and therefore not a marketing genius) by presenting him with the information necessary to determine whether his marketing dollars are being wisely spent.

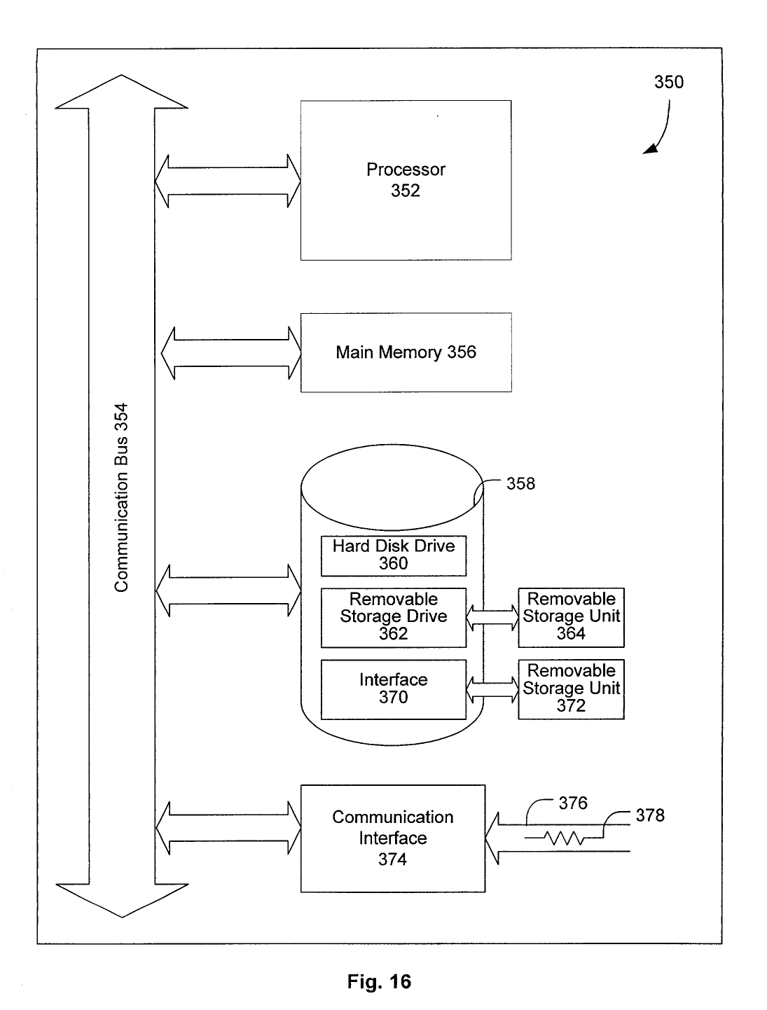

FIG. 16 is a block diagram illustrating an exemplary computer system 350 which may be used in connection with various embodiments described herein. For example, the computer system 350 may be used in conjunction with a client, an online transaction processor, a data warehouse, or to provide connectivity, data storage, and other features useful for operating an online transaction processor, a data warehouse, or a database management system. However, other computer systems and/or architectures may be used, as will be clear to those skilled in the art.

The computer system 350 preferably includes one or more processors, such as processor 352. Additional processors may be provided, such as an auxiliary processor to manage input/output, an auxiliary processor to perform floating point mathematical operations, a special-purpose microprocessor having an architecture suitable for fast execution of signal processing algorithms (“digital signal processor”), a slave processor subordinate to the main processing system (“back-end processor”), an additional microprocessor or controller for dual or multiple processor systems, or a coprocessor. Such auxiliary processors may be discrete processors or may be integrated with the processor 352.

The processor 352 is preferably connected to a communication bus 354. The communication bus 354 may include a data channel for facilitating information transfer between storage and other peripheral components of the computer system 350. The communication bus 354 further may provide a set of signals used for communication with the processor 352, including a data bus, address bus, and control bus (not shown). The communication bus 354 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

Computer system 350 preferably includes a main memory 356 and may also include a secondary memory 358. The main memory 356 provides storage of instructions and data for programs executing on the processor 352. The main memory 356 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, as well as read only memory (ROM).

The secondary memory 358 may optionally include a hard disk drive 360 and/or a removable storage drive 362, for example a floppy disk drive, a magnetic tape drive, an optical disk drive, etc. The removable storage drive 362 reads from and/or writes to a removable storage unit 364 in a well-known manner. Removable storage unit 364 may be, for example, a floppy disk, magnetic tape, optical disk, etc. which is read by and/or written to by removable storage drive 362. The removable storage unit 364 includes a computer usable storage medium having stored therein computer software and/or data.

In alternative embodiments, secondary memory 358 may include other similar means for allowing computer programs or other instructions to be loaded into the computer system 350. Such means may include, for example, a removable storage unit 372 and an interface 370. Examples of secondary memory 358 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage units 372 and interfaces 370, which allow software and data to be transferred from the removable storage unit 372 to the computer system 350.

Computer system 350 may also include a communication interface 374. The communication interface 374 allows software and data to be transferred between computer system 350 and external devices, networks or information sources. Examples of some types of components that might comprise communication interface 374 include a modem, a network interface (such as an Ethernet card), a communications port, a PCMCIA slot and card, and an infrared interface, to name a few. Communication interface 374 preferably implements industry promulgated protocol standards, such as Ethernet IEEE 802 standards, Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement non-standard interface protocols as well. Software and data transferred via communication interface 374 are generally in the form of signals 378 which may be electronic, electromagnetic, optical or other signals capable of being received by communication interface 374. These signals 378 are provided to communication interface 374 via a channel 376. This channel 376 carries signals 378 and can be implemented using wire or cable, fiber optics, a phone line, a cellular phone link, a radio frequency (RF) link, or other communications channels.

Computer programming instructions (i.e., computer programs or software) are stored in the main memory 356 and/or the secondary memory 358. Computer programs can also be received via communication interface 374. Such computer programs, when executed, enable the computer system 350 to perform the features relating to the present invention as discussed herein.

In this document, the term “computer program product” is used to refer to any media used to provide programming instructions to the computer system 350. Examples of these media include removable storage units 364 and 372, a hard disk installed in hard disk drive 360, and signals 378. These computer program products are means for providing programming instructions to the computer system 350.

In an embodiment that is implemented using software, the software may be stored in a computer program product and loaded into computer system 350 using hard drive 360, removable storage drive 362, interface 370 or communication interface 374. The software, when executed by the processor 352, may cause the processor 352 to perform the features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will be apparent those skilled in the relevant art. Various embodiments may also be implemented using a combination of both hardware and software.

While the particular system and method for network based marketing herein shown and described in detail is fully capable of attaining the above described objects of this invention, it is to be understood that the description and drawings represent the presently preferred embodiment of the invention and are, as such, a representative of the subject matter which is broadly contemplated by the present invention. It is further understood that the scope of the present invention fully encompasses other embodiments that may become obvious to those skilled in the art, and that the scope of the present invention is accordingly limited by nothing other than the appended claims.

What is claimed is:

1. A network based marketing system allowing a service provider to obtain new and repeat clients, the system configured to communicate a personalized promotion, the system comprising:
a database containing a plurality of client profiles, wherein each profile includes a network contact address for the respective client;
a network interface configured to receive a promotion from a service provider;
a merge module configured to combine the promotion with each of the respective plurality of client profiles to create a plurality of personalized promotions; and
a communication module configured to send each personalized promotion to each respective client at the network contact address for the respective client.

2. The system of claim 1, further comprising a remote access interface configured to allow a new client to add a profile to the database.

3. The system of claim 2, wherein the remote access interface is further configured to allow the service provider to add, update, and delete profiles in the database.

4. The system of claim 3, wherein the remote access interface is further configured to receive additions, updates, and deletions from the service provider via a web browser.

5. The system of claim 4, wherein the remote access interface requires authorization from the service provider prior to accepting additions, updates, and deletions.

6. The system of claim 1, wherein the network interface is further configured to receive the promotion via a web browser.

7. The system of claim 1, wherein the network interface is configured to receive a set of criteria defining a client profile, the merge module further comprising:
a filter module configured to filter the database of client profiles based on the set of criteria provided by the service provider to create a subset of profiles targeted for receipt of the promotion.

8. The system of claim 7, wherein the merge module further comprises:
a combine module configured to customize the promotion for each client profile in the subset of profiles to create a plurality of personalized promotions.

9. The system of claim 8, wherein the network interface is further configured to receive a date on which the personalized promotions are to be sent.

10. The system of claim 1, wherein the promotion includes a reference to additional network based information regarding the promotion.

11. The system of claim 1, wherein the promotion comprises text, graphics, audio, and video.

12. The system of claim 1, wherein the communication module requires an authorization from the service provider prior to sending the personalized promotions.

13. The system of claim 1, further comprising a scheduling module configured to manage a calendar of events for the service provider.

14. The system of claim 13, wherein the scheduling module is further configured to schedule new appointments.

15. The system of claim 14, wherein the scheduling module is further configured to cancel existing appointments.

16. The system of claim 15, wherein the personalized promotion includes a reference providing access to the scheduling module.

17. The system of claim 16 wherein the scheduling module is further configured to send a personalized message to a client based on information stored in the client profile.

18. The system of claim 17 wherein the personalized message comprises a holiday greeting, a birthday message, an anniversary message, an appointment reminder, and a prescription reminder.

19. The system of claim 1, further comprising a reporting module configured to generate a plurality of reports containing information regarding a personalized promotion.

20. The system of claim 1, further comprising a billing module configured to calculate a total cost for sending the personalized promotions.

21. A computer system including a microprocessor, a persistent storage area containing network contact information for a plurality of clients, a volatile storage area, and a communication means, the computer system configured to communicate a personalized promotion to a client, the computer system further including an execution area configured to receive a promotion, personalize the promotion for each respective client, and send the personalized promotion, via the communication means, to each client at the respective network contact.

22. A method for conducting network based marketing, the method comprising:
receiving a set of criteria from a service provider, the set of criteria describing the characteristics of a desired client profile;
filtering a database containing a plurality of client profiles to determine a group of targeted client profiles meeting the set of criteria;
receiving a promotion from the service provider;
sending the promotion to each client in the group of targeted client profiles, wherein the promotion is sent electronically;
calculating a total number of promotions sent; and
determining a total cost for sending the promotions, wherein the total cost is based on the total number of promotions sent.

23. The method of claim 22, further comprising:
defining a plurality of tiers, wherein each tier encompasses a non-overlapping range;
establishing a unit price for each tier;
calculating a total number of promotions sent; and
determining a total cost for sending the promotions, wherein the total cost is based on the total number of promotions sent in each respective tier and the unit price for each respective tier.

24. The method of claim 22, further comprising:
personalizing the promotion for each client in the group of targeted client profiles.

25. The method of claim 24, further comprising:
receiving a date on which the promotions are to be sent to the group of targeted client profiles.

26. The method of claim 22, further comprising:
providing a reference to additional information within the promotion.

27. The method of claim 22, further comprising:
generating a report for the service provider containing summary information regarding a promotion.

28. The method of claim 22, further comprising:
providing network based access to the database for a new client; and
receiving a new client profile from the new client.

29. The method of claim 28, further comprising:
providing network based access to the database for the service provider;
requiring authorization from the service provider to access the database;
and
receiving additions, updates, and deletions from the service provider.

30. A method for conducting network based marketing, comprising:
searching a database containing a plurality of client profiles for an event pertaining to a client;
composing a personalized message to the client pertaining to the event;
and
sending the personalized message to the client via a network.
